(19) United States
(12) Patent Application Publication
(10) Pub. No.: US 2016/0088178 A1
(43) Pub. Date: Mar. 24, 2016

(54) SYSTEM FOR VIDEO-BASED SCANNING AND ANALYSIS

(71) Applicant: BreezyPrint Corporation, Oakland, CA (US)

(72) Inventor: Jared Hansen, Oakland, CA (US)

(73) Assignee: BreezyPrint Corporation, Oakland, CA (US)

(21) Appl. No.: 14/856,560

(22) Filed: Sep. 17, 2015

Related U.S. Application Data
(60) Provisional application No. 62/052,174, filed on Sep. 18, 2014.

(51) Int. Cl. H04N 1/028; H04N 1/40

(52) U.S. Cl. CPC H04N 1/028; H04N 1/40; H04N 2201/0084; H04N 2201/0434

(57) ABSTRACT

A system for facilitating the processing of a multipage physical document by receiving data from a video recording or video capture of the document; parsing the video data into distinct pages; analyzing each of the pages; and saving the result.

### BACKGROUND

Optical Character Recognition (OCR) and other scanning or image-to-text or image-to-character technologies are increasingly useful in various applications. As OCR and other such conversion technologies are quite processing intensive, however, their use has remained limited to specific hardware and software availability associated with minimum processing power requirements and memory capacities.

### BRIEF DESCRIPTION OF THE DRAWINGS

The foregoing and other features, aspects and advantages of the invention are described in detail below with reference to the drawings of various embodiments, which are intended to illustrate and not to limit the invention. The drawings comprise the following figures in which:

FIG. 1 is a block diagram of a system according to some embodiments; and

FIG. 2 is a block diagram of an apparatus according to some embodiments.

### DETAILED DESCRIPTION

Certain aspects, advantages, and novel features of various embodiments are described herein. It is to be understood that not necessarily all such advantages may be achieved in accordance with any particular embodiment. Thus, for example, those skilled in the art will recognize that embodiments may be effectuated and/or carried out in a manner that achieves one advantage or group of advantages as taught herein without necessarily achieving other advantages as may be taught or suggested herein.

Although several embodiments, examples and illustrations are disclosed herein, it will be understood by those of ordinary skill in the art that the embodiments described herein extend beyond the specifically disclosed embodiments, examples and illustrations and include other uses and obvious modifications and equivalents thereof. Embodiments are described herein with reference to the accompanying figures, wherein like numerals refer to like elements throughout. The terminology used in the description presented herein is not intended to be interpreted in any limited or restrictive manner simply because it is being used in conjunction with a detailed description of certain specific embodiments. In addition, embodiments may comprise several novel features and it is possible that no single feature is solely responsible for its desirable attributes or is essential to practicing the embodiments described herein.

Applicant has recognized that users of mobile computing devices may often desire to scan and/or perform OCR analysis of various physical documents. Such capabilities do not exist or are heavily limited for mobile devices due to limited processing power and/or memory requirements, for example, or are limited to single-page analysis. A user may, for example, be required to utilize a camera of the mobile device to take a snapshot (e.g., image) of a desired page of a document, which page will then be loaded into memory and analyzed utilizing OCR technology. Such single-page processing, however, can be a time-consuming process for target documents, books, magazines, etc., that have a plurality of pages. Applicant has recognized that a system that permits a user to take video of the many pages desired for input, instead of individual photographs, combined with server-based document processing and OCR, may greatly ease the difficulty in achieving multiple-page scanning and/or OCR analysis via mobile devices. Applicant has also recognized that audio recorded as part of or with the video may be analyzed to identify scanning and/or OCR processing commands, codes, and/or preferences that are then utilized to process the video in accordance with embodiments herein.

It should be understood that the embodiments described herein are not limited to use with mobile devices (although the embodiments are described mainly with reference to such devices, for ease of understanding). Any reference to a “mobile device” herein should generally be understood to equally refer to any computing device, as appropriate, unless otherwise specifically limited (e.g., in a claim) to a particular species of mobile device such as, but not limited to, a smart phone, a wireless telephone, a tablet device, “smart” eyewear such as GOOGLE GLASS, and/or a “smart” watch. A “document” as the term is utilized herein, generally refers to any collection of data capable of being rendered on a tangible medium (e.g., paper), such as a WORD, EXCEL or PDF file, or an image file. A “physical document” is a rendering of a document in a physical form—e.g., a fixation of data and/or elements of the document on one or more tangible mediums, such as paper.

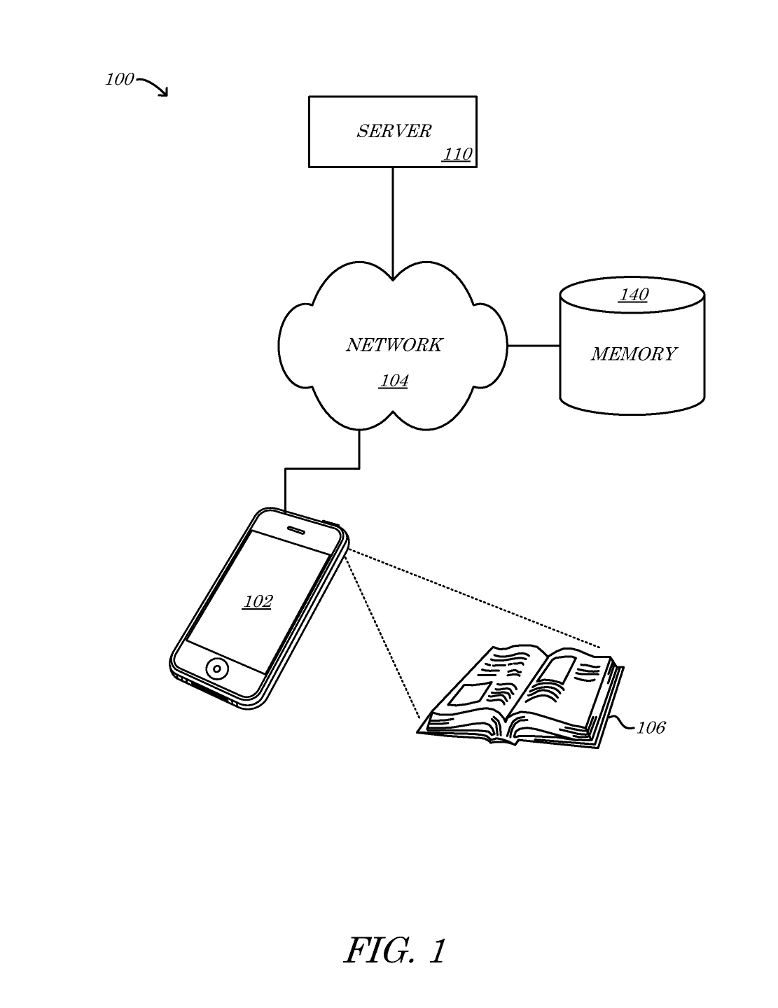

Referring first to FIG. 1, a block diagram of a system 100 according to some embodiments is shown. In some embodiments, the system 100 may comprise a user device 102, a network 104, a physical document 106, a server device 110, and/or a memory device 140. As depicted in FIG. 1, any or all of the devices 102, 110, 140 (or any combinations thereof) may be in communication via the network 104. In some embodiments, the system 100 may be utilized to conduct scanning and/or OCR-type processing of the physical document 106. The user device 102 may, for example, interface with one or more of the server device 110 and/or the memory device 140 to provide video and/or audio data descriptive of the physical document 106 (and/or descriptive of instructions, commands, and/or preference defining how the data descriptive of the physical document 106 should be processed), such video data then being utilized by the server device 110 and/or the memory device 140 to decode, decrypt, scan, convert, and/or analyze the physical document 106.

Fewer or more components 102, 104, 106, 110, 140 and/or various configurations of the depicted components 102, 104, 106, 110, 140 may be included in the system 100 without deviating from the scope of embodiments described herein. In some embodiments, the components 102, 104, 106, 110, 140 may be similar in configuration and/or functionality to similarly named and/or numbered components as described herein. In some embodiments, the system 100 (and/or portion thereof) may comprise a video-based OCR program, system, and/or platform programmed and/or otherwise configured to execute, conduct, and/or facilitate any of the various methods and/or procedures described herein, and/or portions or combinations thereof.

The user device 102, in some embodiments, may comprise any type or configuration of computing, mobile electronic, network, user, and/or communication device that is or becomes known or practicable. The user device 102 may, for example, comprise one or more Personal Computer (PC) devices, computer workstations, tablet computers such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif., or “smart” eyewear such as Google Glass® manufactured by Google®, Inc. of Mountain View, Calif., a “smart watch”, etc. According to some embodiments, the user device 102 may communicate with the server device 110 via the network 104, such as to provide video data descriptive of the physical document 106 for OCR-type analysis (and/or to provide audio defining how the analysis should be conducted), as described herein.

The network 104 may, according to some embodiments, comprise a Local Area Network (LAN; wireless and/or wired), cellular telephone, Bluetooth®, Near Field Communication (NFC), and/or Radio Frequency (RF) network with communication links between the server device 110, the user device 102, and/or the database 140. In some embodiments, the network 104 may comprise direct communications links between any or all of the components 102, 110, 140 of the system 100. The user device 102 may, for example, be directly interfaced or connected to one or more of the server device 110 and/or the memory device 140 via one or more wires, cables, wireless links, and/or other network components, such network components (e.g., communication links) comprising portions of the network 104. In some embodiments, the network 104 may comprise one or many other links or network components other than those depicted in FIG. 1. The user device 102 may, for example, be connected to the server device 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102, 110, 140 of the system 100. The network 104 may comprise one or more cellular telephone networks with communication links between the user device 102 and the server device 110, for example, and/or may comprise the Internet, with communication links between the server device 110 and the memory device 140, for example.

According to some embodiments, the physical document 106 may comprise any physical document and/or object upon which written language, number sequences, and/or other characters are indicated. As depicted, the physical document 106 may comprise a book, magazine, newspaper, and/or other multi-page document and/or object. While depicted as a single, bound collection of pages in FIG. 1, the physical document 106 may comprise, in some embodiments, multiple pages comprised of multiple different documents and/or document types, such as a page of a magazine, three (3) pages of a text book, and a portion of a page of a newspaper.

In some embodiments, the server device 110 may comprise an electronic and/or computerized controller and/or server device such as a computer server communicatively coupled to interface with the user device 102 and/or database 140 (directly and/or indirectly). The server device 110 may, for example, comprise one or more PowerEdge™ M910 blade servers manufactured by Dell®, Inc. of Round Rock, Tex. which may include one or more Eight-Core Intel® Xeon® 7500 Series electronic processing devices. According to some embodiments, the server device 110 may be located remote from one or more of the user device 102 and/or the memory device 140. The server device 110 may also or alternatively comprise a plurality of electronic processing devices located at one or more various sites and/or locations.

According to some embodiments, the server device 110 may store and/or execute specially programmed instructions to operate in accordance with embodiments described herein. The server device 110 may, for example, execute one or more programs that facilitate video-based OCR-type processing of multipage documents (such as the physical document 106). According to some embodiments, the server device 110 may comprise a computerized processing device such as a PC, laptop computer, computer server, and/or other electronic device to manage and/or facilitate transactions, requests, and/or communications regarding the user device 102.

In some embodiments, the server device 110 and/or the user device 102 may be in communication with the memory device 140. The memory device 140 may store, for example, video data, audio data, and/or OCR data obtained from the user device 102, OCR and/or video analysis rules defined by the server device 110, and/or instructions that cause various devices (e.g., the server device 110 and/or the user device 102) to operate in accordance with embodiments described herein. In some embodiments, the memory device 140 may comprise any type, configuration, and/or quantity of memory and/or data storage devices that are or become known or practicable. The memory device 140 may, for example, comprise one or more memory modules, chips, and/or devices and/or an array of optical and/or solid-state hard drives configured to store video, audio, and/or OCR data provided by (and/or requested by) the user device 102, various operating instructions, drivers, etc. While the memory device 140 is depicted as a stand-alone component of the system 100 in FIG. 1, the memory device 140 may comprise multiple components. In some embodiments, a multi-component memory device 140 may be distributed across various devices and/or may comprise remotely dispersed components. Any or all of the user device 102 or the server device 110 may comprise the memory device 140 or a portion thereof, for example.

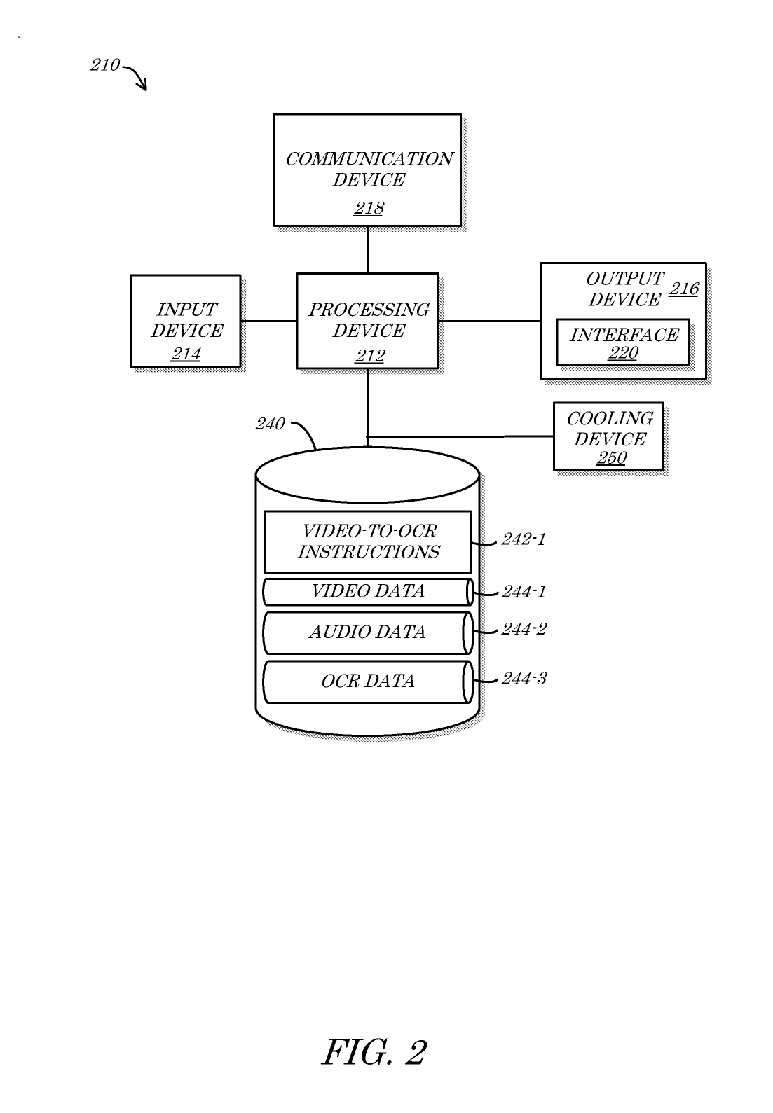

Turning to FIG. 2, a block diagram of a system 210 according to some embodiments is shown. In some embodiments, the system 210 may be similar in configuration and/or functionality to any of the server device 110 or the user device 102 of FIG. 1 herein. The system 210 may, for example, execute, process, facilitate, and/or otherwise be associated with the methods and/or procedures described herein, and/or portions or combinations thereof. In some embodiments, the system 210 may comprise a processing device 212, an input device 214, an output device 216, a communication device 218, an interface 220, a memory device 240 (storing various programs and/or instructions 242 and data 244), and/or a cooling device 250. According to some embodiments, any or all of the components 212, 214, 216, 218, 220, 240, 242, 244, 250 of the system 210 may be similar in configuration and/or functionality to any similarly named and/or numbered components described herein. Fewer or more components 212, 214, 216, 218, 220, 240, 242, 244, 250 and/or various configurations of the components 212, 214, 216, 218, 220, 240, 242, 244, 250 be included in the system 210 without deviating from the scope of embodiments described herein.

According to some embodiments, the processor 212 may be or include any type, quantity, and/or configuration of processor that is or becomes known. The processor 212 may comprise, for example, an Intel® IXP 2800 network processor or an Intel® XEON™ Processor coupled with an Intel® E7501 chipset. In some embodiments, the processor 212 may comprise multiple inter-connected processors, microprocessors, and/or micro-engines. According to some embodiments, the processor 212 (and/or the system 210 and/or other components thereof) may be supplied power via a power supply (not shown) such as a battery, an Alternating Current (AC) source, a Direct Current (DC) source, an AC/DC adapter, solar cells, and/or an inertial generator. In the case that the system 210 comprises a server such as a blade server, necessary power may be supplied via a standard AC outlet, power strip, surge protector, and/or Uninterruptible Power Supply (UPS) device.

In some embodiments, the input device 214 and/or the output device 216 are communicatively coupled to the processor 212 (e.g., via wired and/or wireless connections and/or pathways) and they may generally comprise any types or configurations of input and output components and/or devices that are or become known, respectively. The input device 214 may comprise, for example, a keyboard that allows an operator of the system 210 to interface with the system 210 (e.g., by a user desiring to scan and/or perform OCR analysis on a multipage document as described herein). In some embodiments, the input device 214 may comprise a video camera device (and/or audio captured device—e.g., a microphone) coupled to provide video data descriptive of a multipage physical document (and/or to provide audio instructions defining parameters for physical document processing) to the system 210 and/or the processor 212. The output device 216 may, according to some embodiments, comprise a display screen and/or other practicable output component and/or device. The output device 216 may, for example, provide an interface via which video-based OCR analysis may be initiated and/or the results of such analysis may be viewed, retrieved, stored, sorted, etc. According to some embodiments, the input device 214 and/or the output device 216 may comprise and/or be embodied in a single device such as a touch-screen monitor.

In some embodiments, the communication device 218 may comprise any type or configuration of communication device that is or becomes known or practicable. The communication device 218 may, for example, comprise a Network Interface Card (NIC), a telephonic device, a cellular network device, a router, a hub, a modem, and/or a communications port or cable. In some embodiments, the communication device 218 may be coupled to provide data to a server device, such as in the case that the system 210 is utilized to acquire video data descriptive of a multipage physical document (and/or audio data defining processing or other instructions) and send such data to a server for OCR analysis, as described herein. The communication device 218 may, for example, comprise a cellular telephone network transmission device that sends signals indicative of video capture data (and/or audio captured data) of a multipage document to a remote device. According to some embodiments, the communication device 218 may also or alternatively be coupled to the processor 212. In some embodiments, the communication device 218 may comprise an IR, RF, Bluetooth™, NFC, and/or Wi-Fi® network device coupled to facilitate communications between the processor 212 and another device (such as a user device, server device, and/or a third-party device, not shown in FIG. 2).

The memory device 240 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 240 may, according to some embodiments, store one or more of video-to-OCR instructions 242-1, video data 244-1, audio data 244-2, and/or OCR data 244-3. In some embodiments, the video-to-OCR instructions 242-1 may be utilized by the processor 212 to provide output information via the output device 216 and/or the communication device 218.

According to some embodiments, the video-to-OCR instructions 242-1 may be operable to cause the processor 212 to process the video data 244-1, audio data 244-2, and/or OCR data 244-3 in accordance with embodiments as described herein. Video data 244-1, audio data 244-2, and/or OCR data 244-3 received via the input device 214 and/or the communication device 218 may, for example, be analyzed, sorted, filtered, decoded, decompressed, ranked, scored, plotted, and/or otherwise processed by the processor 212 in accordance with the video-to-OCR instructions 242-1. In some embodiments, video data 244-1, audio data 244-2, and/or OCR data 244-3 may be fed by the processor 212 through one or more mathematical and/or statistical formulas and/or models in accordance with the video-to-OCR instructions 242-1 to identify a physical document for processing, identify and/or separate or parse different distinct pages from a multipage physical document utilizing video capture data, identify document processing instructions and/or supplemental data from audio associated with the video capture data, and/or perform optical character analysis (e.g., OCR) on each separate identified page of the multipage physical document (e.g., in accordance with the audio-derived instructions—e.g., parsed from the video capture feed), as described herein.

In some embodiments, the system 210 may comprise a web server and/or other portal (e.g., an Interactive Voice Response Unit (IVRU)) that provides video-based OCR analysis services and/or functionality to remote mobile devices, such as via the interface 220.

In some embodiments, the system 210 may comprise the cooling device 250. According to some embodiments, the cooling device 250 may be coupled (physically, thermally, and/or electrically) to the processor 212 and/or to the memory device 240. The cooling device 250 may, for example, comprise a fan, heat sink, heat pipe, radiator, cold plate, and/or other cooling component or device or combinations thereof, configured to remove heat from portions or components of the system 210.

Any or all of the exemplary instructions and data types described herein and other practicable types of data may be stored in any number, type, and/or configuration of memory devices that is or becomes known. The memory device 240 may, for example, comprise one or more data tables or files, databases, table spaces, registers, and/or other storage structures. In some embodiments, multiple databases and/or storage structures (and/or multiple memory devices 240) may be utilized to store information associated with the system 210. According to some embodiments, the memory device 240 may be incorporated into and/or otherwise coupled to the system 210 (e.g., as shown) or may simply be accessible to the system 210 (e.g., externally located and/or situated).

According to some embodiments, video data may be captured by a video capture device of a mobile device operated by a user. Such video capture data may, for example, comprise digital video data descriptive of a physical document target such as a book or magazine and/or audio data defining one or more rules, commands, instructions, and/or preferences for document scanning, OCR-analysis, and/or other processing (e.g., sharing, transmission, encryption, and/or other process instructions). In some embodiments, the video capture data (and/or audio data) may be acquired via the mobile device's built-in video camera (and/or microphone) and stored on the mobile device (or other portable device) as a video file. In some embodiments, the video capture data may be acquired via the video camera device as controlled and/or managed by a particular mobile device application such as an application storing specially-programmed instructions configured to manage video-to-OCR processes.

In some embodiments, for example, a user of the mobile device may initiate an application on the mobile device that prompts the user to begin acquiring video footage of the desired multipage document OCR target. The application may further prompt the user, or the user may simply indicate, when the video capture is complete. During the video capture, the user may move the video camera over or across a series (or plurality) of physical document pages, such as by moving the camera's field of view from one document page to the next, or by keeping the camera stationary, but flipping pages of a bound volume (e.g., a book) within the field of view. In such a manner, for example, the video data may be descriptive of the contents of a plurality of physical document pages, portions, etc. In some embodiments, the application may be configured to detect page corners, edges, text boundaries, etc., and may guide the user regarding camera positioning, zoom, etc. In some embodiments, the user may provide audio data with or as part of the video recording. The audio data may define one or more commands, instructions, and/or preferences such as, for example, “save this in my home folder”, “tag this as ‘WORK’”, “send this article to my mom”, and/or “e-mail me a shopping list based on this recipe”. Keywords in the audio such as “recipe”, for example, may trigger or define specific processing actions such as (i) a command to parse the scanned image for food ingredient items and/or quantities of items needed, (ii) an instruction to electronically transmit an electronic copy of the scanned/captured data to a particular electronic address, and/or (iii) a preference to have an electronic copy of the scanned and/or OCR-processed data to a particular network and/or data storage location.

According to some embodiments, the captured video data may transmitted to (and accordingly received by) a server. The server may parse and/or analyze the video data (and/or audio data) such as by performing a frame-by-frame analysis (and/or keyword or command word analysis) to determine a number of distinct pages represented by the data (and/or to identify one or more commands, instructions, and/or preferences). In some embodiments, the server may then perform OCR and/or other digital analysis of the image data (e.g., in accordance with any identified commands, instructions, and/or preferences) to determine one or more characters, words, sentences, phrases, images, and/or other features of the pages (and/or to perform other processing actions such as transmitting, or analyzing the content of the physical document). According to some embodiments, the OCR and/or other analysis may be conducted utilizing an image of a particular page extracted from the video data, such image having been determined either by the user or by the server as being the best (e.g., clearest) representation of the page. Each video frame representative of the page may be analyzed for clarity, for example, and all such frames may be ranked to determine the best candidate frame for conducting OCR and/or other analysis. According to some embodiments, a plurality of highest ranking frames (e.g., top five) may be utilized to conduct OCR and/or other processing, and the results may be compared, averaged, and/or otherwise combined to produce a multi-frame OCR result (e.g., that may achieve a higher accuracy than a single-frame OCR result, such as is possible for a single-image OCR process). Thus, not only may user convenience and efficiency be greatly increased by permitting video captured multipage document data to be quickly and easily scanned and/or OCR analyzed utilizing server-based processing power, but the overall accuracy and/or quality of the results may indeed be better than standard single-frame still picture OCR and/or scanning procedures.

In some embodiments, the scanning and/or OCR results may be stored and/or made available to the user, such as via the application executed by the mobile device. It is presumed, in some embodiments, that the video-based OCR analysis will take some time, even utilizing server-based processing power, so the user may not experience immediate results, but may instead conduct a video-based scan, and have to wait some amount of time for the results to be ready. In such embodiments, the user may be provided with an estimated time of completion, or may receive a text message or mobile device notification when the results are complete and ready for viewing.

### Rules of Interpretation

Numerous embodiments are described in this patent application, and are presented for illustrative purposes only. The described embodiments are not, and are not intended to be, limiting. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments. It is contemplated, however, that while some embodiment are not limited by the examples provided herein, some embodiments may be specifically bounded or limited by provided examples, structures, method steps, and/or sequences. Embodiments having scopes limited by provided examples may also specifically exclude features not explicitly described or contemplated.

Neither the Title (set forth at the beginning of the first page of this patent application) nor the Abstract (set forth at the end of this patent application) is to be taken as limiting in any way the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise. Similarly, any reference to an “alternate”, “alternative”, and/or “alternate embodiment” is intended to connote one or more possible variations—not mutual exclusivity. In other words, it is expressly contemplated that “alternatives” described herein may be utilized and/or implemented together, unless they inherently are incapable of being utilized together.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including the specification, its claims and figures, and anything which may be incorporated by reference, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”. In some embodiments, a first thing being “based on” a second thing refers specifically to the first thing taking into account the second thing in an explicit manner. In such embodiments, for example, a processing step based on the local weather, which itself is in some manner based on or affected by (for example) human activity in the rainforests, is not “based on” such human activities because it is not those activities that being explicitly analyzed, included, taken into account, and/or processed.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “wherein”, as utilized herein, does not evidence intended use. The term “wherein” expressly refers to one or more features inclusive in a particular embodiment and does not imply or include an optional or conditional limitation.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to allow for distinguishing that particular referenced feature from another feature that is described by the same term or by a similar term. For example, a “first widget” may be so named merely to allow for distinguishing it in one or more claims from a “second widget”, so as to encompass embodiments in which (1) the “first widget” is or is the same as the “second widget” and (2) the “first widget” is different than or is not identical to the “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; (3) does not indicate that either widget ranks above or below any other, as in importance or quality; and (4) does not indicate that the two referenced widgets are not identical or the same widget. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein. According to some embodiments, a “processor” may primarily comprise and/or be limited to a specific class of processors referred to herein as “processing devices”. “Processing devices” are a subset of processors limited to physical devices such as CPU devices, Printed Circuit Board (PCB) devices, transistors, capacitors, logic gates, etc. “Processing devices”, for example, explicitly exclude biological, software-only, and/or biological or software-centric physical devices. While processing devices may include some degree of soft logic and/or programming, for example, such devices must include a predominant degree of physical structure in accordance with 35 U.S.C. §101.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

While various embodiments have been described herein, it should be understood that the scope of the present invention is not limited to the particular embodiments explicitly described. Many other variations and embodiments would be understood by one of ordinary skill in the art upon reading the present description.

### Computerized Processing

Various embodiments described herein provide advantages in computer processing. The number of pages of physical documents that can effectively be input, processed, and output in accordance with embodiments herein, for example, would not be possible without implementation of such embodiments in a specialized computer processing system. Such a system as described herein may, for example, enable processing of tens, hundreds, and/or thousands of pages of physical document content in minutes, hours, or within a day, while such processing would not be possible in the absence of such a system. For convenience, such a specially-programmed system may be referred to herein as a “specialized computer processing system”. In other words, embodiments conducted by a specialized computer processing system may not be possible to achieve in the absence of such a system and/or the speed at which such a system operates would simply not be reproducible by other available means. As a non-limiting example, a specialized computer processing system herein may be capable of receiving input descriptive of, processing, and outputting processed representations of, twenty (20) pages of physical document content in less than one (1) hour.

What is claimed is:

1. A system for facilitating the processing of a multipage physical document, comprising:
receiving, by a server device, data from a video recording or video capture of the multipage physical document;
parsing, by the server device, said data, the parsing resulting in an identification of a plurality of distinct pages of the multipage physical document;
conducting, by the server device, an analysis on each of the identified distinct pages of the multipage physical document; and
saving, by the server device, an electronic file or files comprised of the result of the analysis conducted by the server device on the pages of the multipage physical document.

2. The system of claim 1, wherein the analysis conducted on each of the identified distinct pages of the multipage physical document comprises optical character recognition.

3. The system of claim 1, wherein the data from a video recording or video capture includes audio data and the audio data is used to influence or direct the processing or analysis of the multipage physical document.

4. The system of claim 1, further comprising:
providing, by the server device and to a display device via a network, the saved electronic file or files comprising the result of the analysis.

5. The system of claim 2, wherein the saved electronic file or files resulting from the analysis conducted by the server device are editable electronic versions of the pages of the multipage physical document.

6. The system of claim 5, wherein the display device is the device from which the server received the data from a video recording or capture of the multipage physical document.

7. The system of claim 1, wherein the parsing further results in an identification of a plurality of video frames depicting a particular page of the multipage physical document, the conducting comprises performing the analysis for each frame in a set of video frames depicting a particular page of the multipage physical document, and further comprising:
combining, by the server device, the results of the analysis for each frame in a set of video frames depicting a particular page of the multipage physical document, thereby creating a single electronic version of a particular page of the multipage physical document.

8. The system of claim 7, wherein the frames in a set of video frames depicting the particular page of the multipage physical document are combined by selecting the analyzed data point (e.g., pixel or individual character) that appears most frequently within the set of individual frames for each potential data point.

9. The system of claim 7, wherein the frames in a set of video frames depicting the particular page of the multipage physical document are combined by providing the set of individual frames to a neural network trained to output a single frame from the set of individual frames.

10. The system of claim 7, wherein the data from a video recording or video capture includes audio data and the audio data is used to influence or direct the processing or analysis of the multipage physical document.

11. The system of claim 1, wherein the parsing further results in an identification of a plurality of video frames depicting a particular page of the multipage physical document, the conducting comprises performing the analysis on a single frame generated from the set of video frames depicting a particular page of the multipage physical document, wherein the single frame comprises the output of a neural network trained to output a single representative frame from the set of individual frames.

12. The system of claim 2, wherein the parsing further results in an identification of a plurality of video frames depicting a particular page of the multipage physical document, the conducting comprises performing the optical character recognition analysis for each frame in a set of video frames depicting the particular page of the multipage physical document, and further comprising:
combining, by the server device, the results of the optical character recognition analysis for each frame in a set of video frames depicting a particular page of the multipage physical document, thereby creating a single electronic version of the particular page of a multipage physical document.

13. The system of claim 12, further comprising:
providing, by the server device and to a display device via a network, the saved electronic file or files comprising the result of the analysis.

14. The system of claim 13, wherein the display device is the device from which the server received the data from a video recording or video capture of the multipage physical document.

15. The system of claim 12, wherein the frames in a set of video frames depicting a particular page of the multipage physical document are combined by selecting the analyzed data point (e.g., pixel or individual character) that appears most frequently within the set of individual frames for each data point.

16. The system of claim 12, wherein the set of video frames depicting a particular page of the multipage physical document are combined by providing the set of individual frames to a neural network trained to output a single representative frame from the set of individual frames.

17. The system of claim 12, wherein the data from a video recording or video capture includes audio data and the audio data is used to influence or direct the processing or analysis of the multipage physical document.
